(19) United States
(12) Patent Application Publication
(10) Pub. No.: US 2005/0218688 A1
(43) Pub. Date: Oct. 6, 2005

(54) Windscreen wiping device, especially for a motor vehicle

(76) Inventors: Achim Neubauer, Sinzheim-Vormberg (DE); Peter Kalchschmidt, Bruchsal Untergromb (DE); Martin-Peter Bolz, Buehl (DE); Jochen Moench, Sinzheim (DE); Hartmut Krueger, Buehlertal (DE); Ken Zschweigert, Stuttgart (DE)

Correspondence Address: MICHAEL BEST & FRIEDRICH, LLP, 100 E WISCONSIN AVENUE, MILWAUKEE, WI, 53202, US

(21) Appl. No.: 10/481,900

(22) PCT Filed: Feb. 8, 2002
(86) PCT No.: PCT/US02/03540

§ 371 Date: Dec. 23, 2003

(30) Foreign Application Priority Data
Feb. 7, 2002 (DE) 102 05 019.8

(51) Int. Cl. B60S 1/06; B60S 1/04

(52) U.S. Cl. 296/96.17; 15/250.31; 15/250.3

(57) ABSTRACT

A windshield wiper apparatus (10), in particular for a motor vehicle, is proposed with at least one drive device, which is able to drive at least one wiper shaft (18) in at least a pendulum fashion, on which a wiper arm bearing a wiper blade can be fastened, whereby binders (24) to fasten the windshield wiper apparatus (10) are provided.

### STATE OF THE ART

The invention relates to a windshield wiper apparatus, in particular for a motor vehicle, in accordance with the pre-characterizing clause of the independent claim.

Numerous windshield wiper apparatuses for motor vehicles are already known. These apparatuses feature a drive device that drives a wiper shaft in a pendulum fashion, on which a wiper arm bearing a wiper blade on its free end is fastened, which glides over the window of the vehicle thereby cleaning the window.

These windshield wiper apparatuses are normally fastened to the vehicle by means of screwed or riveted connections. In this case, special eyelets or eyes with rubber bushings must be provided on the windshield wiper apparatus, through which fastening screws or threaded rods can be fed. These solutions are expensive in terms of manufacturing since the threaded rods normally have to be welded onto the body before the windshield wiper apparatus is mounted and they are complicated in terms of assembly on the production line since small parts like nuts and washers have to be attached by hand. The nuts can become wedged during insertion or the threaded rods can break off when the nuts are being tightened. As a result, the angular position and the tightening torque of the nuts must be correctly selected and controlled.

### ADVANTAGES OF THE INVENTION

The windshield wiper apparatus in accordance with the invention with the features of the main claim has the advantage that the windshield wiper apparatus can be fastened to the motor vehicle by means of a binder. This results in the possibility of using a simple and cost-effective means for fastening the windshield wiper apparatus which can be obtained in large unit numbers cost-effectively and of sufficient quality. In addition, binders are considerably simpler in terms of handling than screws since they only have to be clamped and do not require any separate elements on the windshield wiper apparatus or the vehicle body through which screws can be fed or onto which nuts can be inserted. In addition, considerably less space is required to clamp the binder than to tighten a screw since screwed connections must be considerably more accessible than the binder fastening in accordance with the invention in order to prevent the tool from becoming wedged during assembly. An assembly robot can also manipulate binders in particular in a simple way.

The measures listed in the sub-claims result in advantageous developments and improvements of the features indicated in the main claims.

A fastening element for locking the binder is advantageously used to increase the stability and service life of the connection.

In addition, it is also advantageous if the binder can be fastened via winding to a holding bridge fastened to the motor vehicle. As a result, the windshield wiper apparatus is fastened in the simplest way to the motor vehicle, and despite this, adequate hold and adequate vibrational stability of the fastening are achieved. This is applied in particular when the holding bridge has a free end, so that the binder does not have to be threaded through but only has to be slid on.

The vibrating behavior of the windshield wiper apparatus is advantageously improved by attaching damping elements.

In addition, it is advantageous if at least one binder is embodied of plastic since plastics can be obtained very cost-effectively in high-level quality.

In addition, it is advantageous if at least one binder is embodied of metal since metal binders can be subjected to a higher level of stress, as is the case with commercial vehicles or sport utility vehicles, for example.

In this case, it is particularly advantageous if the binder is embodied of plastic with a metal reinforcement. On the one hand this solution is cost-effective, and on the other hand the advantages of the materials of plastic and metal are combined with each another. Thus plastic bands can be reinforced with metal threads, thereby exhibiting a high level of strength, and despite this, be provided with adequate softness in the binder for damping vibrations.

In addition, it is also particularly advantageous if at least one axial element is provided, which prevents an axial displacement of the windshield wiper apparatus since the axial stability of a connection of a binder is naturally weaker than the radial stability.

### DRAWINGS

Exemplary embodiments of the invention are depicted in the drawings and explained in more detail in the following description. They show:

FIG. 1 shows a perspective representation of a windshield wiper apparatus in accordance with the invention.

FIG. 2 shows a perspective section through a support tube of a windshield wiper apparatus in accordance with the invention.

FIG. 3 shows a variation of the section from FIG. 2.

FIG. 4 shows a perspective representation of a motor holder plate of a windshield wiper apparatus in accordance with the invention.

FIG. 5 shows a view from below of the motor holder plate from FIG. 4.

### DESCRIPTION OF THE EXEMPLARY EMBODIMENTS

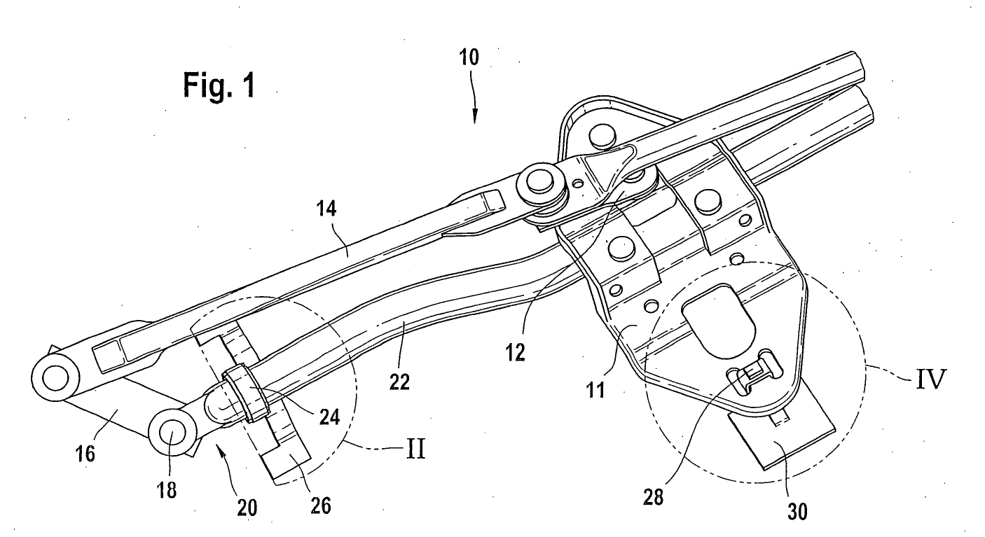

FIG. 1 shows a perspective representation of a windshield wiper apparatus 10 in accordance with the invention.

The windshield wiper apparatus 10 is comprised essentially of a drive device (not shown here), typically an electric motor, which puts a motor crank 12 that is tightly connected to its driven shaft into a rotational motion or a pendulum motion. Coupled with this driven crank 12 is a thrust rod 14, which also puts a driving crank 16 into a pendulum motion via the movement of the driven crank 12. Connected tightly with the driving crank 16 is a wiper shaft 18, which is put into a rotational motion during a rotational or pendulum motion of the driven crank 12 so that a wiper arm (not shown here) tightly connected to the wiper shaft executes a pendulum motion.

The wiper shaft 18 is positioned in a wiper bearing 20, which is connected to a support tube 22 or is embodied as a single part with it. The support plate 11 that bears the drive device is fastened to the support tube 22.

The windshield wiper apparatus 10 is connected to the body of the motor vehicle by means of binders 24 via a holding bridge 26. In addition, the support plate 11 is also connected to the body of the motor vehicle at another location with another binder 28 and another holding bridge 30.

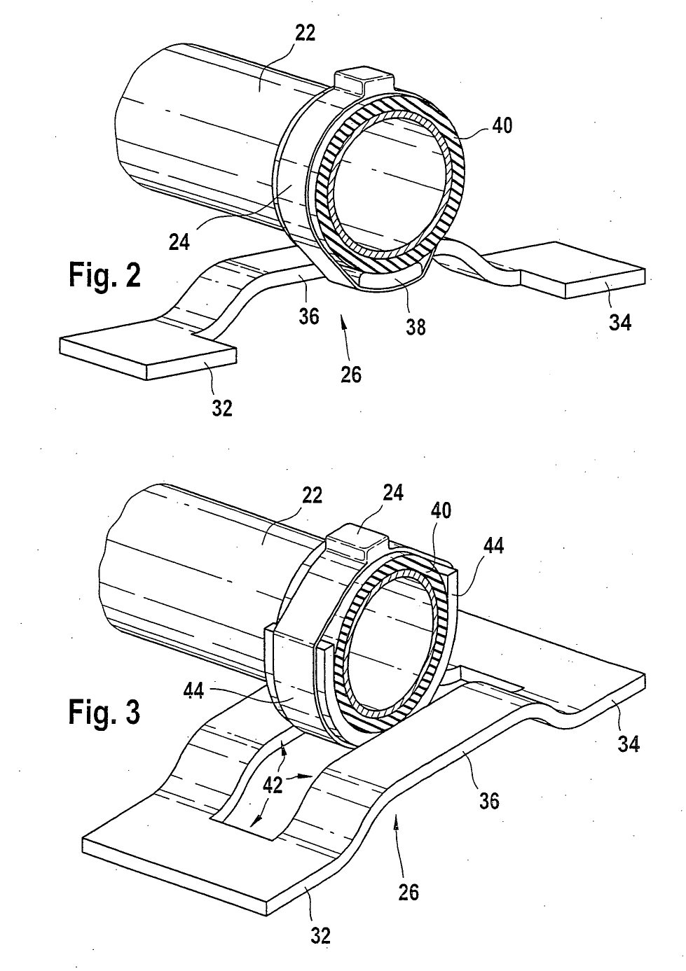

FIG. 2 depicts in detail the section of the fastening area shown in FIG. 1 with the binder 24 and the holding bridge 26. In this case, the holding bridge 26 features essentially three sections and essentially has an elongated, bridge-like shape. The two outer sections 32, 34 are embodied in such a way that they can be fastened in a simple manner to the body of the motor vehicle. They essentially have a flat shape and are arranged in such a way in relation to one another that corresponds to the contour of the body at the point at which they are supposed to be fastened. Elevated from this contour, which is a plane in this case, is the center section 36 that forms the bridge between the two outer sections 32, 34. A projection 38 around which the binder 24 binds is embodied laterally to the longitudinal extension of the center section 36. In this case, the binder 24 is embodied as a metallic band, preferably as a steel band, and winds around the support tube 22 and around the projection 38 as a free end of the holding bridge 26 so that these two are solidly connected to one another. In order to improve the vibrating behavior of the windshield wiper apparatus 10, an annular rubber collar 40 is arranged around the support tube 22 in the area of the binder 24 as a damping element. This collar can naturally also be formed in such a way that it forms an at least partially positively engaged unit with the holding bridge 26, the support tube 22 and the binder 24.

FIG. 3 depicts a variation of the fastening area shown in FIG. 2. The holding bridge 26 in this case also has essentially a bridge-like shape and also features essentially three sections, the outer sections 32, 34 and a center section 36. A punched-out section whose edges 42 describe a U is provided in the center of the longitudinal extension of the center section 36. The basis of this U-shaped punched-out section in this case is approximately in the area of the outer sections 32, 34. The brackets 44 that are generated in this way are bent in such a way that they follow the contour of the support tube 22 or the contour of the damping element 40. The support tube 22 with the damping element 40 is carried like this in a cradle-like manner by the holding bridge 26 and fastened by the binder 24 that is guided around the brackets 44 and the damping element 40.

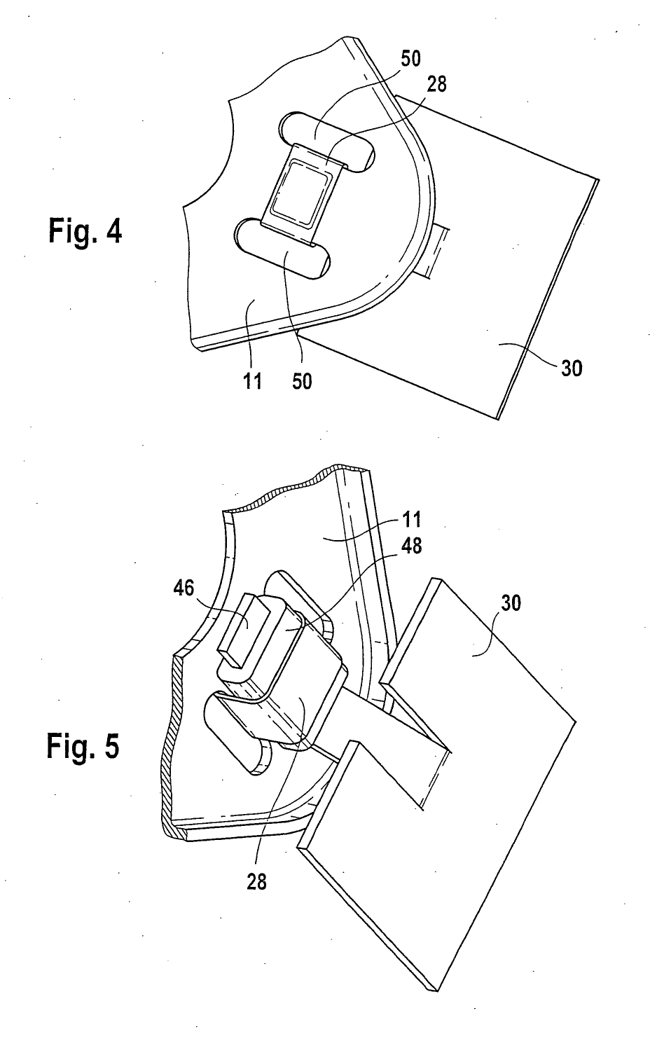

FIG. 4 depicts the fastening area of the support plate 11 from FIG. 1 in detail. The additional holding bridge 30 is comprised in this case of a flat piece of sheet metal out of which a bracket 46 is punched. The free end of the bracket 46 is surrounded by a plastic body, e.g. a rubber collar, as an additional damping element 48 and carries the support plate 11. In order to fix the support plate 11 on the bracket 46, it features two openings as fastening elements 50, which are arranged next to the additional damping element 48 on both sides in an assembled state. The additional binder 28 is wound through these two openings 50 and around the additional damping element 48 so that the support plate 11 is fixed on the additional holding device 30. As a rule, the fastening element 50 can also be comprised only of the damping element 48 as depicted in FIG. 1.

FIG. 5 depicts the fastening area from FIG. 4 in a view from below, i.e., viewed from the side of the vehicle body. The binder 24 as well as the additional binder 28 are essentially arranged perpendicular to one another, which results in an especially stable connection since the direction of the best possible fixing is formed by the direction of the longitudinal extension of the binder 24, 28.

In a variation of the invention, an at least partially circulating taper can be provided on the support tube 22 as an axial element and thus as a further fastening element 50, which prevents an axial displacement of the binder 24 and thus the windshield wiper apparatus 10. The holding bridges 26, 30 are typically embodied as a single piece with the vehicle body or are welded, glued or fastened in another manner directly onto the vehicle body. In order to prevent a rotation of the windshield wiper apparatus 10 around a center of the loop formed by the binder 24, the fastening element, e.g. the supporting tube 22, can feature a shape that varies from a circular one. In the simplest case this can be an elliptical shape, or even better, be a shape which at least a bend or location that has a positive engagement with a holding bridge 26.

The axial slipping of the binder 24, 28 can be prevented by an annular or pin-shaped elevation from the support tube 22. The binders 24, 28 themselves are typically embodied of metal reinforced plastic or of metal bands so that a relaxation is prevented. The Hellermann company, for example, offers these types of bands in the Tyton “M Series”. Bands made of rust-free materials are particularly suitable for preventing corrosion. In addition, defined prestress forces on the fastening can be achieved via integrated spring elements in the receptacle.

In principle, it should be noted in terms of the design that only low forces can be transmitted in the axial direction of the fastening, i.e., traverse to the longitudinal extension of the binder 24. Therefore, axial elements are provided, which for example can be embodied as twists of the holding bridge 26 and the support tube 22 or as beads in the supporting tube 22.

In addition, the bearing positions must be designed in such a way that all possible directions of movement are fixed and sufficient accuracy particularly of the wiper shafts 18 is achieved on the outside of the vehicle. Thus, for example, during installation in the wiper shaft 18 on the driver's side of the motor vehicle, the can be fastened first with one binder 24, whereby the windshield wiper apparatus 10 is fixed in all three directions in space. Finally, the other binders can then be tensioned.

As a rule, for reasons of stability, the binders 24 should be arranged as far outside as possible on the windshield wiper apparatus 10. In addition, it is possible to loosely fasten the binder 24 already before the windshield wiper apparatus 10 is installed and to tension the binder 24 after the windshield wiper apparatus 10 has been installed via the projection 38 of the holding bridge 26. For example, a nose or a bolt that limits the axial play of the binder 24 can supplement the arrangement in order to prevent the binder 24 from sliding off.

The binders 24 themselves can also be manufactured of carbon fiber material or of glass reinforced plastic or carbon fiber reinforced plastic. In principle, binders 24 made of ceramic materials are also conceivable.

1. Windshield wiper apparatus (10), in particular for a motor vehicle, with at least one drive device, which is able to drive at least one wiper shaft (18) in at least a pendulum fashion, on which a wiper arm bearing a wiper blade can be fastened, characterized in that the windshield wiper apparatus (10) can be fastened with at least one binder (24).

2. Windshield wiper apparatus (10) according to claim 1, characterized in that at least one fastening element (50) for locking the at least one binder (24) is provided.

3. Windshield wiper apparatus (10) according to claim 1, characterized in that at least one binder (24) can be fastened via winding to a holding bridge (26) that can be fastened to the motor vehicle.

4. Windshield wiper apparatus (10) according to claim 3, characterized in that the holding bridge (26) and/or the fastening element (50) is provided with a damping element (40, 48).

5. Windshield wiper apparatus (10) according to claim 1, characterized in that at least one binder (24) is embodied at least partially of metal.

6. Windshield wiper apparatus (10) according to claim 1, characterized in that at least one binder (24) is embodied at least partially of plastic.

7. Windshield wiper apparatus (10) according to claim 6, characterized in that at least one binder (24) is embodied of plastic with a metal reinforcement.

8. Windshield wiper apparatus (10) according to claim 1, characterized in that at least one axial element is provided, which prevents an axial displacement of the windshield wiper apparatus (10).
